(19) United States
(12) Patent Application Publication
(10) Pub. No.: US 2024/0135280 A1
(43) Pub. Date: Apr. 25, 2024

(54) MONITORING TRANSFORMER CONDITIONS IN A POWER DISTRIBUTION SYSTEM

(71) Applicant: International Business Machines Corporation, Armonk, NY (US)

(72) Inventor: Dzung Tien Phan, Pleasantville, NY (US)

(73) Assignee: International Business Machines Corporation, Armonk, NY (US)

(21) Appl. No.: 17/972,182

(22) Filed: Oct. 23, 2022

(51) Int. Cl. G06Q 10/06; G06Q 50/06

(52) U.S. Cl. CPC G06Q 10/06312; G06Q 50/06

(57) ABSTRACT

An embodiment includes receiving, by a transformer monitoring system associated with a transformer, sensor data from one or more sensors during operation of the transformer. The embodiment also includes generating, by the transformer monitoring system, energy loss data representative of a predicted energy loss of the transformer based at least in part on the sensor data. The embodiment also includes training, by the transformer monitoring system, a failure rate prediction model using failure data, resulting in a trained failure rate prediction model that calculates failure probability distribution data indicative of a time at which a failure of the transformer is most likely to occur. The embodiment also includes generating, by the transformer monitoring system, replacement data representative of an optimal time for replacing the transformer based at least in part on the energy loss data, the failure probability distribution data, and specification data for the transformer.

### BACKGROUND

The present invention relates generally to distribution transformers. More particularly, the present invention relates to a method, system, and computer program for monitoring conditions associated with a distribution transformers in a power system.

Transformers are electrical devices that are used extensively in power distribution systems wherever changes in AC voltage levels are needed. It is estimated that over 90% of the electrical power distributed to consumers in the United States passes through a transformer. Transformers are most commonly used to step up or step-down AC voltage levels at various points between power generation and consumer locations. In a typical power distribution system, transformers step up the voltage for long-distance transmission because electricity is transmitted more efficiently at higher voltage levels. Other downstream transformers then step down the voltage to service levels for homes and businesses.

### SUMMARY

The illustrative embodiments provide for monitoring transformer conditions in a power distribution system. An embodiment includes receiving, by a transformer monitoring system associated with a transformer, sensor data from one or more sensors during operation of the transformer. The embodiment also includes generating, by the transformer monitoring system, energy loss data representative of a predicted energy loss of the transformer based at least in part on the sensor data from the one or more sensors. The embodiment also includes training, by the transformer monitoring system, a failure rate prediction model using failure data, resulting in a trained failure rate prediction model that calculates failure probability distribution data indicative of a time at which a failure of the transformer is most likely to occur. The embodiment also includes generating, by the transformer monitoring system, replacement data representative of an optimal time for replacing the transformer based at least in part on the energy loss data, the failure probability distribution data, and specification data for the transformer. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a simplified diagram of an example electric power delivery system in accordance with an illustrative embodiment;

FIG. 3 depicts a simplified diagram of an example distribution transformer in accordance with an illustrative embodiment;

FIG. 4 depicts a block diagram of an example distribution transformer monitoring environment in accordance with an illustrative embodiment;

FIG. 5 depicts a simplified diagram of an example distribution transformer monitoring environment in accordance with an illustrative embodiment;

FIG. 6 depicts a block diagram of an example distribution transformer monitoring environment in accordance with an illustrative embodiment;

FIG. 7 depicts a block diagram of an example transformer monitoring module in accordance with an illustrative embodiment;

FIG. 8 depicts a flowchart of an example process for monitoring a transformer in accordance with an illustrative embodiment; and

FIG. 9 depicts a flowchart of an example process for generating an optimal replacement schedule in accordance with an illustrative embodiment.

### DETAILED DESCRIPTION

Transformers used in power distribution systems are large, heavy devices that present several challenges in terms of manufacturing, installation, and maintenance. A transformer of this type, sometimes referred to as a distribution transformer, typically includes a magnetic core made of a ferromagnetic material as well as primary and secondary windings wound over the magnetic core. The windings of the transformer are insulated to prevent short circuits between successive turns. The core and windings are housed in a metal enclosure and submerged in transformer oil that acts as a coolant and an electrical insulator.

Over time, various environmental and operational factors cause gradual weakening of transformer components and insulation. These factors usually include exposure to heat, vibrations, power surges, moisture, and various other mechanical and magnetic stresses. Eventually the insulation will degrade to the point where a complete insulation breakdown occurs, allowing an electrical hot-spot or short-circuit to manifest within the transformer, leading to complete operational failure.

Detecting an imminent transformer failure is not a trivial task. The components that are subject to wear are submerged in oil and contained within a solid metal enclosure. As a result, the wear that occurs over time is not readily observable. During operation, the voltage and current levels handled by the transformer present a hazard to inspectors. Therefore, the transformer must typically be de-energized before maintenance can be performed.

Replacing a transformer presents several technical challenges as well. Transformers are large, heavy devices that must be built to precise specifications. As a result, the manufacturing of a transformer involves several complex processes and techniques. It is not unusual for a transformer to weigh in excess of 1,000 kg (or several thousand pounds), which presents logistical challenges for their transport and installation. Special training and equipment are required for the tasks involved in replacing a transformer, not only because of the difficulties involved in transporting and positioning such large and heavy devices, but also because of the technical aspects of properly connecting the transformer and integrating it into a power distribution system. Also, in recent years, the materials used to manufacture transformers, and the transformers themselves, have been subject to high demand and supply shortages, with lead times for acquiring a new transformer often exceeding two years or more. As a result, failure to properly maintain and timely replace aging transformers may ultimately lead to a transformer failure and a power outage condition. On the other hand, the technical challenges involved in replacing a transformer make it undesirable to perform such replacements more often than necessary, so premature replacement of operational transformers is undesirable as well.

Illustrative embodiments address these challenges using an approach for monitoring transformer conditions in a power distribution system considers a combination of energy losses, capacity limits, and asset health conditions. A transformer monitoring module (and associated method) uses data associated with the monitoring of the transformer conditions to analyze each transformer for a respective optimal replacement schedule. In some embodiments, an optimal replacement schedule provides an indication of a future point in time as an optimal time for replacing the associated transformer. The precision or specificity of the actual time frame indicated by the optimal time for replacing the associated transformer may vary in different embodiments. For example, in some embodiments, the indication of a future point in time is an indication of a future year, month, or day such that the future year, month, or day constitutes the optimal time for replacing the associated transformer.

In an illustrative embodiment, a transformer monitoring module monitors a plurality of distribution transformers that are part of an electric power delivery system. Each of the distribution transformers provides time-series sensor data to the transformer monitoring module. In various embodiments, the sensors generate time-series sensor data representative of various parameters of the distribution transformers and provide the time-series sensor data to the transformer monitoring module. The sensors may include, as non-limiting examples, current sensors, voltage sensors, temperature sensors, vibration sensors, oil level sensors, and humidity sensors.

In an illustrative embodiment, the transformer monitoring module monitors incoming data for values that satisfy conditions for taking some action, such as issuing an alert to a grid operator or triggering a grid management action. Examples of triggered actions may include various simple actions, such as detecting a current spike and generating log data to record the current spike as an anomaly. In some embodiments, other examples of triggered actions may include more complex actions, for example fault location, isolation, and service restoration (FLISR) actions, such as locating faults and automatically restoring the distribution grid using advanced distribution automation equipment typically included in Smart Grid deployments.

In an illustrative embodiment, the transformer monitoring module collects incoming data associated with each distribution transformer. In some embodiments, the transformer monitoring module uses the collected data with spatial and temporal models to estimate optimal replacement schedules for each of the distribution transformers. In some embodiments, the transformer monitoring module identifies an asset, such as a particular one of the distribution transformers, to analyze for an optimal replacement schedule. In some embodiments, an optimal replacement schedule provides an indication of a future point in time as an optimal time for replacing the associated transformer. The precision or specificity of the actual time frame indicated by the optimal time for replacing the associated transformer may vary in different embodiments. For example, in some embodiments, the indication of a future point in time is an indication of a future year such that the future year constitutes the optimal time for replacing the associated transformer.

In an illustrative embodiment, the transformer monitoring module collects specification data for the identified asset and geography data for the location of the identified asset from an information resource, for example a public and/or private data repository, database, Internet or intranet website, or other information resource. Examples of specification data include rated capacity (kVA), mounting type (pole or pad mounted), primary/secondary voltages, delta/wye configuration, power factor and efficiency, as well as others that may be desired depending upon the specific implementation. Examples of geography data include information related to weather conditions, particularly where there may be extreme conditions that could affect the operation of the transformer, and location, which is useful for determining travel times for purposes of planning maintenance or replacement timetables.

In an illustrative embodiment, the transformer monitoring module collects network data for the distribution transformer's power distribution network. In some embodiments, the information about the power distribution network provides an indication as to the extent to which the power distribution network presently depends on the particular distribution transformer under evaluation, including dependencies and interactions between the distribution transformer and other assets. This information allows for replacement or other maintenance activities to be planned so as to minimize scheduled or unscheduled down time due to unforeseen dependencies or failures.

In an illustrative embodiment, the transformer monitoring module uses an energy loss model together with the collected data to perform an energy loss analysis that includes generating energy loss data representative of a predicted energy loss of a transformer. In some embodiments, the transformer monitoring module identifies an asset to be analyzed from among the monitored transformers, using a predefined schedule or other selection technique. For example, in some embodiments, the transformer monitoring module periodically performs the energy loss analysis on each transformer in an electric power delivery system. In some embodiments, the transformer monitoring module performs the energy loss analysis on a particular transformer in an electric power delivery system “on demand” (i.e., responsive to a system or user request for an energy loss analysis of a particular transformer or other asset).

In an illustrative embodiment, the transformer monitoring module collects certain data about a transformer (or other asset) identified for an energy loss analysis, such as specification data, network data, geographic data, and time-series sensor data (e.g., such as the specification data, network data, geographic data, and time-series sensor data). The transformer monitoring module then uses the energy loss model together with the data collected for the identified asset to perform an energy loss analysis that includes generating energy loss data representative of a predicted energy loss of the transformer.

Energy losses in any system may typically include mechanical losses and electrical losses. In the case of a transformer, mechanical losses are usually negligible because of the static nature of transformers. The electrical loss in a transformer can be defined as the difference between the input power and the output power of the transformer. The two primary sources of electrical loss in a transformer are iron losses (also known as core losses) and copper losses. Thus, in some embodiments, the transformer monitoring module uses the energy loss model together with the data collected for the identified asset to perform an energy loss analysis that includes generating energy loss data, where the energy loss data includes a predicted winding energy loss of a winding structure and a predicted core energy loss of a core of the transformer.

In an illustrative embodiment, the transformer monitoring module generates core energy loss data representative of a predicted core energy loss of the core of the transformer. Core energy losses, also referred to as iron losses, include eddy current loss and hysteresis loss, which are independent of the load, but vary depending on the magnetic properties of the material used for the core. Hysteresis loss occurs due to a magnetic reversal in the core, and depends on the volume/grade of iron, the frequency of magnetic reversals, and the value of flux density. Eddy current loss occurs due to heat that is dissipated because of small circulating currents that occur in the core. Since core energy loss is independent of load, the transformer monitoring module may determine the core energy loss based on transformer specifications, which may include a rated iron loss that is representative of an amount of power loss in Watts (W) at rated load caused by hysteresis and eddy currents in the core. In some embodiments, the transformer monitoring module 700 may determine the core energy loss using an energy loss model that extrapolates the rated iron loss value over time.

In an illustrative embodiment, the transformer monitoring module generates winding energy loss data representative of a predicted winding energy loss, also referred to as copper loss, of the winding structure. Copper losses are due to ohmic resistance of the transformer windings and therefore vary with the load. In some embodiments, the transformer monitoring module may determine the winding energy loss for each winding according to the P=I²R power of each winding (treating the voltage V as constant) where I is current and R is resistance. The I²R power of each winding is equivalent to the product of the voltage and current (P=I²R=VI) of each winding, so power of each winding can be monitored using the time-series voltage and current data sensed by a current sensor and a voltage sensor on the transformer. In some embodiments, the transformer monitoring module receives the voltage and current data from the current and voltage sensors, calculates the power on each of the windings using the voltage and current data, and stores the resulting power data. In the present example, a one-year time frame is used for the analysis, so the transformer monitoring module would store at least one year of power data or keeps track of maximum power values that occur during a rolling one-year period. Where other time periods are used, the retained data would be sufficient to provide the maximum power values for the period of time being used for evaluation.

In an illustrative embodiment, the transformer monitoring module uses incoming specification, geography, and sensor data to generate health analysis data for the specified asset. In some embodiments, the transformer monitoring module generates aging conditions data for the specified asset using a transformer aging model. There are various known aging models that may be used by the transformer monitoring module. For example, in some embodiments, the transformer monitoring module uses known techniques for modeling transformer aging based on a top-oil temperature rise and a superimposed thermal gradient representing a hot-spot temperature rise. In some such embodiments, transformer aging is modeled by solving the heat transfer equations for the top-oil temperature and the hot-spot temperature in the windings. In some embodiments, the transformer monitoring module receives time-series sensor data from one or more temperature sensors that includes data indicative of the top-oil temperature and the hot-spot temperature in the windings. In some such embodiments, the transformer monitoring module receives the time-series temperature data and generates aging conditions data representative of an operational age of the transformer based at least in part on the time-series temperature data from the temperature sensor. Transformers age at different rates based on the ambient temperature, load, cooling mechanism, and insulation type. The hot-spot temperature will degrade some types of insulation faster than others. For example, paper insulation is particularly susceptible to damage caused by excessive heat. The break-down of the insulation is essentially irreversible damage, thus having the effect of aging the transformer. Thus, the operational age provides a more accurate indication of the health condition of a transformer, and thereby allows for a more accurate prediction of an amount of time that the transformer is likely to remain operational.

In some embodiments, the transformer monitoring module uses a failure rate prediction model to predict the failure probability of a transformer. For example, in some embodiments, the transformer monitoring module calculates failure probability distribution data indicative of the likelihood of a transformer failure occurring over a specified period of time. In some embodiments, the probability distribution has a maximum probability value that indicates when a failure of the specified transformer is most likely to occur. In some such embodiments, the transformer monitoring module calculates the probability distribution for a specified transformer using a Weibull distribution model as the failure rate prediction model.

In some embodiments, the Weibull distribution model S(t|η, β)=F(t)=e−^{(t/η)}^{^{β}} includes a shape parameter and a scale parameter. The shape parameter (β) affects the “skew” of the distribution such that for β<1, the failure rate would generally decrease over time, for β>1, the failure rate would generally increase over time, and for β=1 the failure rate is constant over time. The scale parameter (η) affects the “width” of the distribution such that as η decreases, the distribution approaches a tall, narrow spike, whereas as η increases, the height of the distribution decreases as the distribution curve widens.

In some embodiments, the shape parameter (β) and the scale coefficient (η) are based on past failure rates of transformers. For example, in some embodiments, the transformer monitoring module trains the Weibull distribution model using historical failure rate data indicative of specific past failure rates of similar transformers. In some such embodiments, the transformer monitoring module trains the Weibull distribution model using a training algorithm, such as regression or maximum likelihood estimation (MLE), to determine the shape parameter (β) and the scale coefficient (η) that will yield the most accurate trained failure rate prediction model. However, over time, as newer transformers replace aging transformers in a power distribution system, the failure rate of the newer transformers may differ from those being replaced. Therefore, in some embodiments, the transformer monitoring module periodically re-trains the Weibull distribution model (e.g., using regression or MLE) to determine updated shape parameter (β) and scale coefficient (η) values that will improve the accuracy of the trained failure rate prediction model for the newer transformers. In some such embodiments, where historical data for actual failures of the newer transformers is not yet available, the transformer monitoring module re-trains the Weibull distribution model using failure rate data received from the manufacturer or another third party or using failure rate data that has been generated based on specification data from the manufacturer.

In an illustrative embodiment, the transformer monitoring module uses incoming specification and network data to generate capacity limit and network impact data for the identified asset. In some embodiments, the capacity data can be extracted from specification data for the specified transformer. For example, the specification data typically will include information regarding operational limits of the transformer, such as voltage and power ratings, temperature ratings, etc. In some embodiments, this information is used for replacement planning to automatically source a replacement, or provide users with replacement options, which match the capacity limits of the transformer being replaced. Also, in some embodiments, the transformer monitoring module uses incoming network data for the specified asset, particularly regarding portions of the power distribution network that are connected directly to, or dependent in some way upon, the specified asset. In some embodiments, the information about the power distribution network provides an indication as to the extent to which the power distribution network presently depends on the specified asset, including dependencies and interactions between the distribution transformer and other assets. This information allows for replacement or other maintenance activities to be planned so as to minimize scheduled or unscheduled down time due to unforeseen dependencies or failures.

In an illustrative embodiment, the transformer monitoring module monitors incoming data for values associated with specified alert conditions and, responsive to such data, the transformer monitoring module automatically generates and issues alerts associated with the specified alert conditions. Non-limiting examples of alerts automatically generated and issued by the transformer monitoring module include writing to a log file, displaying a message, and/or sending an email or other type of message. Non-limiting examples of alert conditions include non-standard environmental or operational states of a distribution transformer, such as an extreme temperature that is above or below a standard operating temperature range, an open access panel, or a momentary anomalous current or voltage level.

In an illustrative embodiment, the transformer monitoring module monitors incoming data for values associated with specified event conditions and, responsive to such data, the transformer monitoring module automatically triggers events associated with the specified event conditions. Non-limiting examples of events automatically triggered by the transformer monitoring module include various simple actions, such as detecting a current spike and generating log data to record the current spike as an anomaly. In some embodiments, other examples of triggered actions may include more complex actions, for example fault location, isolation, and service restoration (FLISR) actions, such as locating faults and automatically restoring the distribution grid using advanced distribution automation equipment typically included in Smart Grid deployments.

In an illustrative embodiment, the transformer monitoring module generates automated asset replacement schedule data representative of replacement recommendations on a component-by-component basis for assets included in a monitored power distribution network. In some embodiments, the transformer monitoring module periodically performs a replacement optimization analysis on each transformer or other asset in an electric power delivery system and updates the schedule as necessary based on updated incoming data. In some embodiments, the transformer monitoring module performs the replacement optimization analysis on a particular transformer or other asset in an electric power delivery system “on demand” (i.e., responsive to a system or user request for an energy loss analysis of a particular transformer or other asset). In some embodiments, the transformer monitoring module collects the energy efficiency data generated by the energy loss model, aging conditions data, failure probability distribution data, system impact data, and capacity limit data. The transformer monitoring module then generates optimized replacement data for replacing the specified asset using the energy efficiency data, aging conditions data, failure probability distribution data, and system impact data.

In some embodiments, the transformer monitoring module uses the energy efficiency data, aging conditions data, failure probability distribution data, and system impact data to compute the total cost of ownership (TCO) of combined time periods before and after replacement at any point in time as measured in years. In some embodiments, the TCO includes three components: the replacement cost, the failure cost, and the energy losses. In some such embodiments, TCO (t_{R}) is a function of the replacement time point t_{R}, which is minimized using an optimization algorithm.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

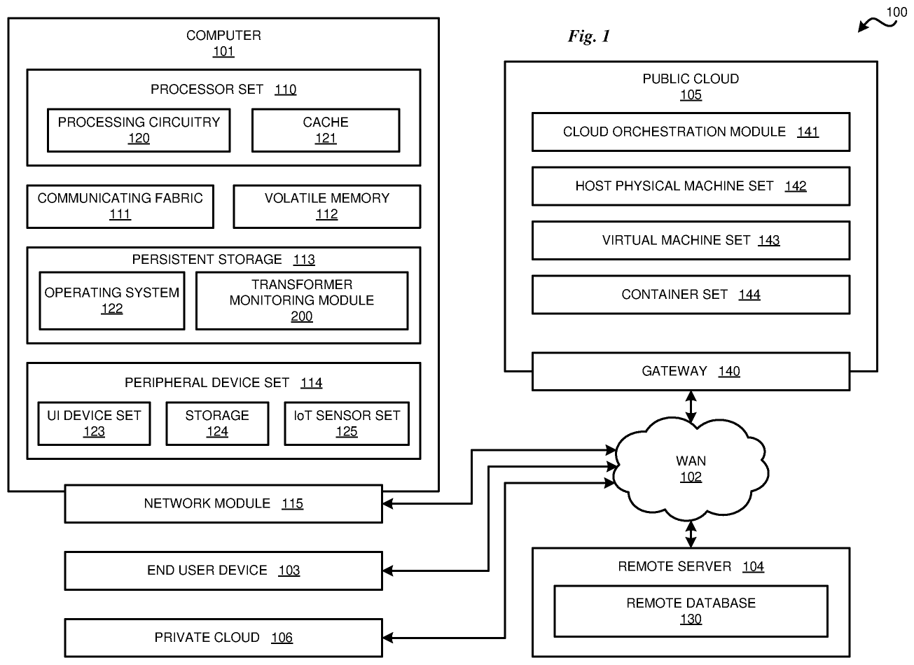

With reference to FIG. 1, this figure depicts a block diagram of a computing environment 100. Computing environment 100 contains an example of an environment for the execution of at least some of the computer code involved in performing the inventive methods, such as an improved transformer monitoring module 200 that monitors energy loss, capacity limit, and health condition of distribution transformers, allowing computer 101 to operate as an example of a transformer monitoring system. In addition to transformer monitoring module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and transformer monitoring module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in transformer monitoring module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in transformer monitoring module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

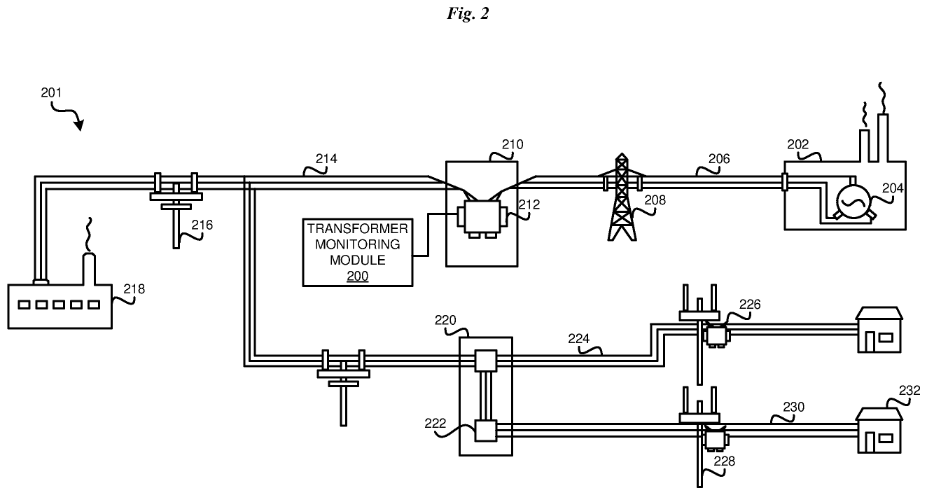

With reference to FIG. 2, this figure depicts a simplified diagram of an example electric power delivery system 201 in accordance with an illustrative embodiment. In the illustrated embodiment, the electric power delivery system 201 includes the transformer monitoring module 200 of FIG. 1.

In the illustrated embodiment, the electric power delivery system 201 generates, transmits, and distributes electrical energy to loads. The electric power delivery system 201 is shown as a non-limiting example. Alternative embodiments can include generating stations that produce electrical power; electrical substations for stepping electrical voltage up for transmission, or down for distribution; high voltage transmission lines that carry power from distant sources to demand-centers; and transmission lines that connect individual customers. Power stations may be located away from heavily populated areas, for instance near a fuel source or at a river/reservoir dam. The electric power generated is stepped up to a higher voltage at which it connects to an electric power transmission network. The transmission network moves the power long distances until it reaches regional electric power distribution network. On arrival at a substation, the power is stepped down from a transmission level voltage to a distribution-level voltage. As it exits the substation, it enters the local distribution network. Finally, upon arrival at the service location, the power is stepped down again from the distribution voltage to the required service voltage.

As illustrated, the electric power delivery system 201 includes electric power generating station 202 where an electric generator 204 is installed. The electric power delivery system 201 also includes primary transmission lines 206 and towers 208 that deliver power to a secondary distribution station 210 that includes a distribution transformer 212. The distribution transformer 212 supplies power to secondary transmission lines 214 that are supported by poles 216. Power is then provided to industrial consumers 218 and a secondary distribution station 220, which includes circuit breakers 222 to control the flow of power in the system. Finally, secondary transmission lines 224 supported by poles 228 distribute power to pole-mounted distribution transformers 226, such that local transmission lines 230 provide power to residential consumers 232. Although not shown, it should be noted that a variety of other types of equipment may also be included in electric power delivery system 201, such as voltage regulators, capacitors, capacitor banks, and suitable other types of equipment useful in power generation, transmission, and/or distribution, and that local transmission lines may be buried rather than supported by poles.

The electricity that power plants (e.g., the electric power generating station 202) generate is delivered to customers over transmission and distribution systems. It is well established that high-voltage, low-current transmission results in lower power line losses. Therefore, higher voltage electricity is more efficient and less expensive for long-distance electricity transmission, while lower voltage electricity is safer for use in homes and businesses.

The electric power delivery system 201 includes a primary transmission system and a secondary transmission system. The primary transmission system (e.g., including transmission lines 206 and towers 208) provide electricity at a high voltage (e.g., voltage levels ranging from 34.5 kV to over 20 kV) over long distances from a generating station 202 to regional secondary transmission system(s) (e.g., including secondary transmission lines 214 and 224, secondary distribution station 220, and distribution transformers 226). The secondary transmission system(s) provide electricity from transmission systems to local customers. On arrival at the secondary distribution station 210, power is stepped down from a transmission level-voltage to a distribution-level voltage (e.g., 11 kV or 13 kV) by the distribution transformer 212. At this stage, a medium industrial customer (e.g., such as industrial consumers 218) may connect directly to the distribution wiring. At the secondary distribution station 220, circuit breakers 222 control the flow of electricity among transmission lines to service locations, where the voltage is stepped down further to service voltages (e.g., 120 V, 240 V, and 480 V) using the pole-mounted distribution transformers 226.

Thus, distribution transformers, such as distribution transformer 212 and distribution transformers 226 adjust the electric voltage to a suitable level for each segment of the electric power delivery system 201 from the generator to the end users. While not shown, it is well known that an electric power delivery system may also include distribution transformers that step up voltage at power generating station 202 for efficient, long-haul transmission of electricity. Additional distribution transformers may also be used to step the voltage either up or down at various points where there is a change in voltage in the electric power delivery system 201. As such, the distribution transformers play a critical role in that they assist the electric power delivery system 201 in efficiently and effectively providing power to various consumers.

The size of a distribution transformer may be determined by a primary (input) voltage, a secondary (output) voltage, and a load capacity measured in volt-ampere (VA). In addition to the load capacity rating, voltage ratings are often used to describe different classes of power transformers. For example, large power transformers (LPTs) with voltage ratings of 115 kV and above are considered high voltage (HV), and LPTs with voltage ratings of 345 kV and above are considered extra high voltage (EHV). Distribution transformers can carry a substantial amount of electricity. Therefore, a faulty or damaged distribution transformer can affect the transmission/distribution capacity of a regional electric power grid, possibly leading to extended power outages. By monitoring the distribution transformer operating status using the transformer monitoring module 200, which may include various sensors, meters, current transformers, load tap changers, and intelligent electronic devices, regional power system operators may predict when a single LPT in a substation may go offline and plan ahead for its replacement to avoid power outages.

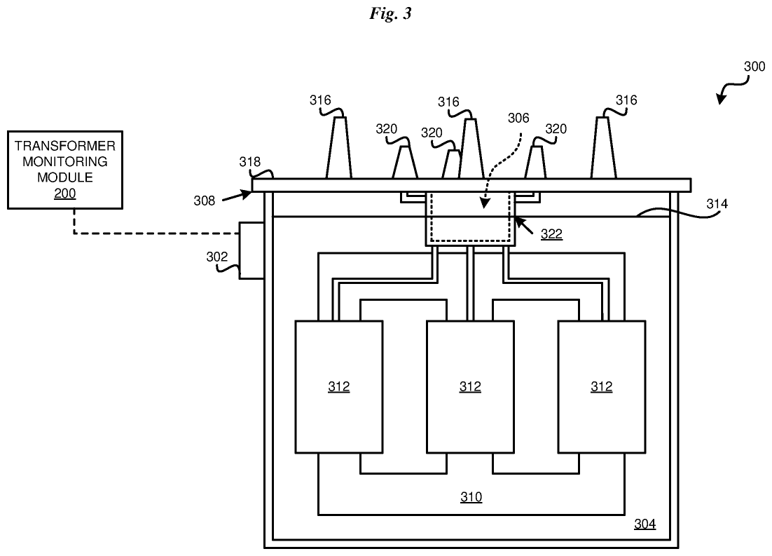

With reference to FIG. 3, this figure depicts a simplified diagram of an example distribution transformer 300 in accordance with an illustrative embodiment. In the illustrated embodiment, the distribution transformer 300 includes a remote terminal unit (RTU) 302 that collects time-series sensor data from a transformer sensor bank 306 and provides the time-series sensor data to the transformer monitoring module 200. In some embodiments, the distribution transformer 300 is an example of the distribution transformer 212 of FIG. 2.

In the illustrated embodiment, the distribution transformer 300 is a three-phase, liquid-cooled distribution transformer having a kVA capacity rating in a range of from about 112.5 kVA to about 15,000 kVA. A high voltage side of the distribution transformer 300 has a voltage in a range of from about 600 V to about 35 kV, while a low voltage side of the distribution transformer 300 has a voltage in a range of from about 120 V to about 15 kV. The distribution transformer 300 generally includes an electromagnetic transformer 304 and a tank or housing 308.

In the illustrated embodiment, the electromagnetic transformer 304 includes a ferromagnetic core 310 and three winding structures 312, one for each phase. The core 310 is comprised of ferromagnetic metal (e.g., iron or an iron alloy, such as silicon grain-oriented steel) and may be generally rectangular in shape. The core 310 and the winding structures 312 are immersed in a dielectric fluid 314 inside the housing 308. Each winding structure 312 includes a primary winding structure and a secondary winding structure, each of which are wound on the ferromagnetic core 310. The primary winding structure comprises one or more primary windings and the secondary winding structure comprises one or more secondary windings. The primary winding structure and the secondary winding structure may be mounted concentrically to a leg of the core 310, with the secondary winding structure being disposed within and radially inward from the primary winding structure. The primary winding structures may be connected in a Y or Δ (delta) configuration and the secondary winding structures may be connected in a Y or Δ configuration. Thus, the electromagnetic transformer 304 may have a Y-Y, Y-Δ, Δ-Y, or Δ-Δ configuration.

In the illustrated embodiment, the primary windings for the three phases are connected to respective high voltage bushings 316 mounted to a top wall 318 of the housing 308. The secondary windings for the three phases are connected to respective low voltage bushings 320 mounted to the top wall 318. The sensor bank 306 is protected by an access panel 322 and includes various combinations of sensors depending on the parameters sought to be monitored and analyzed. For example, in some embodiments, the sensor bank 306 includes some combination of current sensors (e.g., current transformers), voltage sensors (e.g., potential transformers), temperature sensors, vibration sensors, oil level sensors, and/or humidity sensors. In some embodiments, the sensors of the sensor bank 306 periodically take measurements and transmit them in the form of time-series sensor data to the RTU 302. In some embodiments, the RTU 302 is configured to periodically transmit the time-series sensor data to the transformer monitoring module 200. In some embodiments, one or more of the sensors of the sensor bank 306 are analog sensors that provide analog data to the RTU 302, and the RTU 302 converts the analog sensor data to digital sensor data and then transmits the digital sensor data to the transformer monitoring module 200.

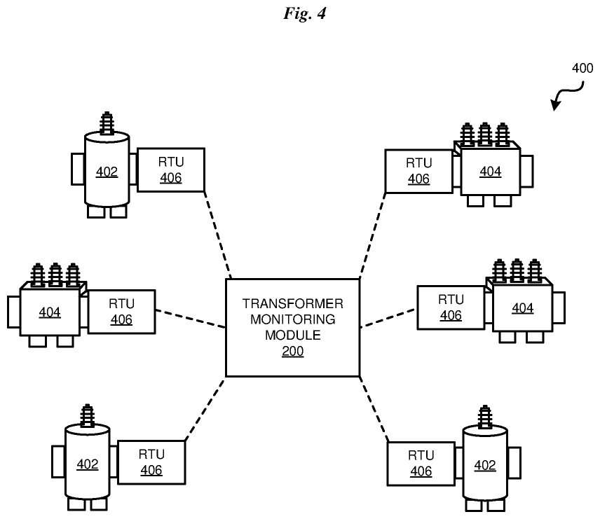

With reference to FIG. 4, this figure depicts a block diagram of an example distribution transformer monitoring environment 400 in accordance with an illustrative embodiment. In the illustrated embodiment, the distribution transformer monitoring environment 400 includes a plurality of distribution transformers 402 and 404 that are part of an electric power delivery system (e.g., electric power delivery system 201 of FIG. 2) and all provide time-series sensor data to the transformer monitoring module 200. As illustrated in the embodiment shown in FIG. 4, the transformer monitoring module 200 may be configured to receive time-series sensor data from multiple distribution transformers, as well as from multiple types of distribution transformers. Specifically, in FIG. 4 the transformer monitoring module 200 receives time-series sensor data from a plurality of pole-mounted distribution transformers 402 and from a plurality of pad-mounted distribution transformers 404.

Each of the distribution transformers 402/404 includes a respective RTU 302 that collects and sends time-series sensor data to the transformer monitoring module 200. In some embodiments, the RTUs 406 examples of the RTU 302 of FIG. 3. In various embodiments, the RTUs may communicate with the transformer monitoring module 200 using wired and/or wireless communications.

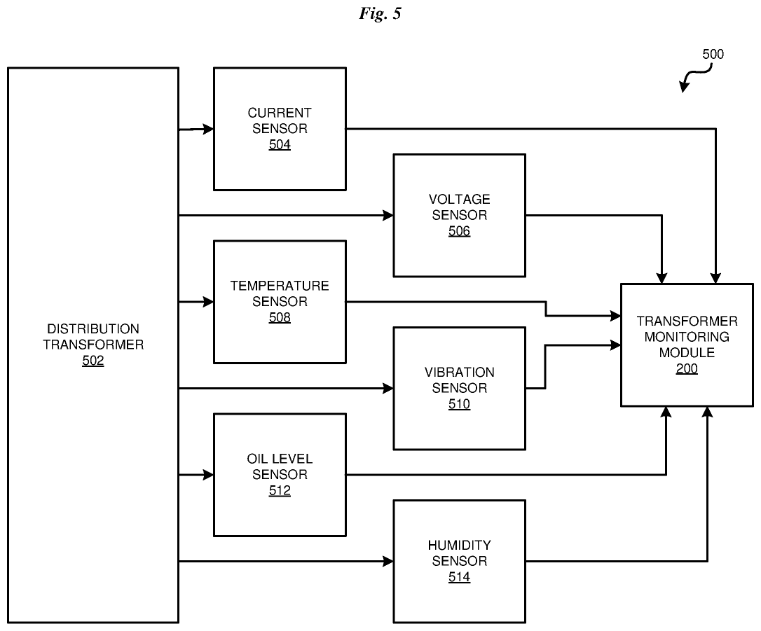

With reference to FIG. 5, this figure depicts a simplified diagram of an example distribution transformer monitoring environment 500 in accordance with an illustrative embodiment. In the illustrated embodiment, the distribution transformer monitoring environment 500 includes a distribution transformer 502 that is part of an electric power delivery system (e.g., electric power delivery system 201 of FIG. 2).

In the illustrated embodiment, a plurality of sensors generate time-series sensor data representative of various parameters of the distribution transformer 502 and provide the time-series sensor data directly to the transformer monitoring module 200. Thus, as illustrated in FIG. 5, in some embodiments the transformer monitoring module 200 receives the time-series sensor data directly from the sensors rather than from an intermediate device such as the RTUs 406 of FIG. 4.

In the illustrated embodiment, the sensors include, as non-limiting examples, a current sensor 504, a voltage sensor 506, a temperature sensor 508, a vibration sensor 510, an oil level sensor 512, and a humidity sensor 514. In some embodiments, the current sensor 504 includes one or more current transformers that measure the current through the primary or secondary windings of the distribution transformer 502, and/or the voltage sensor 506 includes one or more potential transformers that measure the voltage across the primary or secondary windings of the distribution transformer 502. In some embodiments, the temperature sensor 508 measures top-oil temperature and temperature of the primary and/or secondary windings of the distribution transformer 502. In some embodiments, the temperature sensor 508 comprises an integrated circuit that generates an analog signal that is proportional to the one or more measured temperatures. In some embodiments, the vibration sensor 510 senses displacement, velocity, and acceleration parameters of vibrations and outputs time-series sensor data having values proportional to each of these three parameters. In some embodiments, the oil level sensor 512 uses a float mechanism that outputs an analog voltage signal representative of the level of oil inside the transformer housing. In some embodiments, the humidity sensor 514 senses relative humidity by measuring both air temperature and moisture. In some embodiments, the humidity sensor 514 outputs time-series sensor data indicative of a humidity percentage, which is a ratio of moisture currently present in the air to the total amount of moisture that air, at the measured temperature, can hold. In some embodiments, the humidity sensor 514 generates time-series sensor data indicative of humidity based on changes in temperature or changing electrical currents in the air.

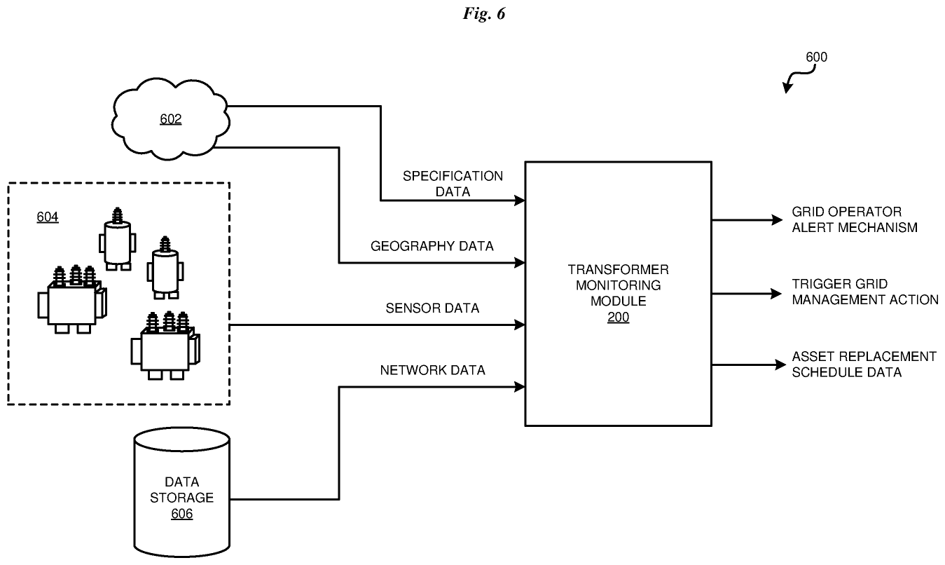

With reference to FIG. 6, this figure depicts a block diagram of an example distribution transformer monitoring environment 600 in accordance with an illustrative embodiment. In the illustrated embodiment, the transformer monitoring module 200 receives time-series sensor data from a plurality of transformers 604 in the same manner as described in connection with FIG. 5.

In the illustrated embodiment, the transformer monitoring module 200 monitors incoming data for values that satisfy conditions for taking some action, such as issuing an alert to a grid operator or triggering a grid management action. Examples of triggered actions may include various simple actions, such as detecting a current spike and generating log data to record the current spike as an anomaly. In some embodiments, other examples of triggered actions may include more complex actions, for example fault location, isolation, and service restoration (FLISR) actions, such as locating faults and automatically restoring the distribution grid using advanced distribution automation equipment typically included in Smart Grid deployments.

In the illustrated embodiment, the transformer monitoring module 200 collects incoming data associated with each distribution transformer. In some embodiments, the transformer monitoring module 200 uses the collected data with spatial and temporal models to estimate optimal replacement schedules for each of the distribution transformers. In some embodiments, the transformer monitoring module 200 identifies an asset, such as a particular one of the distribution transformers, to analyze for an optimal replacement schedule. In some embodiments, an optimal replacement schedule provides an indication of a future point in time as an optimal time for replacing the associated transformer. The precision or specificity of the actual time frame indicated by the optimal time for replacing the associated transformer may vary in different embodiments. For example, in some embodiments, the indication of a future point in time is an indication of a future year such that the future year constitutes the optimal time for replacing the associated transformer.

In the illustrated embodiment, the transformer monitoring module 200 collects specification data for the identified asset and geography data for the location of the identified asset from an information resource, generally shown as network resources 602. Network resources 602 may include public and/or private data repositories, databases, Internet or intranet websites, or other information resources. Examples of specification data include rated capacity (kVA), mounting type (pole or pad mounted), primary/secondary voltages, delta/wye configuration, power factor and efficiency, as well as others that may be desired depending upon the specific implementation. Examples of geography data include information related to weather conditions, particularly where there may be extreme conditions that could affect the operation of the transformer, and location, which is useful for determining travel times for purposes of planning maintenance or replacement timetables.

In the illustrated embodiment, the transformer monitoring module 200 collects network data for the distribution transformer's power distribution network from data storage 606, which may be a local or remote database or data repository or any other data source where network data may be made available. In some embodiments, the information about the power distribution network provides an indication as to the extent to which the power distribution network presently depends on the particular distribution transformer under evaluation, including dependencies and interactions between the distribution transformer and other assets. This information allows for replacement or other maintenance activities to be planned so as to minimize scheduled or unscheduled down time due to unforeseen dependencies or failures.

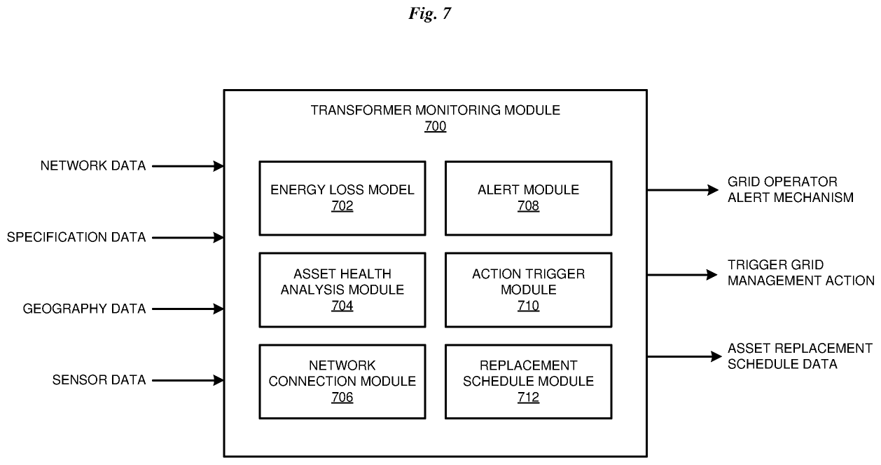

With reference to FIG. 7, this figure depicts a block diagram of an example transformer monitoring module 700 in accordance with an illustrative embodiment. In a particular embodiment, the transformer monitoring module 700 is an example of transformer monitoring module 200 of FIGS. 1-6.

In the illustrated embodiment, the transformer monitoring module 700 includes an energy loss model 702, an asset health analysis module 704, a network connection module 706, an alert module 708, an action trigger module 710, and a replacement schedule module 712. In alternative embodiments, the transformer monitoring module 700 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the transformer monitoring module 700 uses the energy loss model 702 together with data collected for an identified transformer or other asset to perform an energy loss analysis that includes generating energy loss data representative of a predicted energy loss of the transformer. In some embodiments, the transformer monitoring module 700 identifies an asset to be analyzed, such as one of the transformers 604 of FIG. 6, using a predefined schedule or other selection technique. For example, in some embodiments, the transformer monitoring module 700 periodically performs the energy loss analysis on each transformer or other asset in an electric power delivery system (e.g., electric power delivery system 201 of FIG. 2). In some embodiments, the transformer monitoring module 700 performs the energy loss analysis on a particular transformer or other asset in an electric power delivery system “on demand” (i.e., responsive to a system or user request for an energy loss analysis of a particular transformer or other asset).

In some embodiments, the transformer monitoring module 700 collects certain data about a transformer (or other asset) identified for an energy loss analysis, such as specification data, network data, geographic data, and time-series sensor data (e.g., such as the specification data, network data, geographic data, and time-series sensor data discussed in connection with FIGS. 5 and 6). The transformer monitoring module 700 then uses the energy loss model 702 together with the data collected for the identified asset to perform an energy loss analysis that includes generating energy loss data representative of a predicted energy loss of the transformer.

Energy losses in any system may typically include mechanical losses and electrical losses. In the case of a transformer, mechanical losses are usually negligible because of the static nature of transformers. The electrical loss in a transformer can be defined as the difference between the input power and the output power of the transformer. The two primary sources of electrical loss in a transformer are iron losses (also known as core losses) and copper losses. Thus, in some embodiments, the transformer monitoring module 700 uses the energy loss model 702 together with the data collected for the identified asset to perform an energy loss analysis that includes generating energy loss data, where the energy loss data includes a predicted winding energy loss of a winding structure and a predicted core energy loss of a core of the transformer.

In some embodiments, the transformer monitoring module 700 generates core energy loss data representative of a predicted core energy loss of the core of the transformer. Core energy losses, also referred to as iron losses, include eddy current loss and hysteresis loss, which are independent of the load, but vary depending on the magnetic properties of the material used for the core (e.g., core 310 of FIG. 3). Hysteresis loss occurs due to a magnetic reversal in the core, and depends on the volume/grade of iron, the frequency of magnetic reversals, and the value of flux density. Eddy current loss occurs due to heat that is dissipated because of small circulating currents that occur in the core. Since core energy loss is independent of load, the transformer monitoring module 700 may determine the core energy loss based on transformer specifications, which may include a rated iron loss P_{O} that is representative of an amount of power loss in Watts (W) at rated load caused by hysteresis and eddy currents in the core. In some embodiments, the transformer monitoring module 700 may determine the core energy loss using an energy loss model that extrapolates the rated iron loss value over time, for example using expression (1):

V_{O}(t)=365*24*P_{O} (1)

Where V_{O} is the total energy loss due to iron loss specified over a year of operation in Watt-Hours (Wh).

In some embodiments, the transformer monitoring module 700 generates winding energy loss data representative of a predicted winding energy loss, also referred to as copper loss, of the winding structure. Copper losses are due to ohmic resistance of the transformer windings (e.g., winding structures 312 of FIG. 3) and therefore vary with the load. In some embodiments, the transformer monitoring module 700 may determine the winding energy loss for each winding according to the P=I²R power of each winding (treating the voltage as constant). The I²R power of each winding is equivalent to the product of the voltage and current (P=I²R=VI) of each winding, so power of each winding can be monitored using the time-series voltage and current data sensed by the current sensor 504 and voltage sensor 506 of FIG. 5. In some embodiments, the transformer monitoring module 700 receives the voltage and current data from the current and voltage sensors, calculates the power on each of the windings using the voltage and current data, and stores the resulting power data. In the present example, a one-year time frame is used for the analysis, so the transformer monitoring module 700 would store at least one year of power data or keeps track of maximum power values that occur during a rolling one-year period. Where other time periods are used, the retained data would be sufficient to provide the maximum power values for the period of time being used for evaluation. The total energy loss due to copper loss can thus be determined using expression (2):

V_{K}=T_{V}(Pₘₐₓ/P)²P_{K} (2)

Where Pₘₐₓ is the is the maximum power consumed at any time during the time period (i.e., one year in this example), and V_{K} is the total energy loss due to copper loss specified over a year of operation in Wh. T_{V} is the time period of maximum loss, and can be determined using expression (3):

T_{V}=c(T_{b})+(1−c)(T_{b}²/(365*24)) (3)

In expression (3), T_{b} is the time period of maximum load (typically in a range between and including 3000 and 5000 hours) and c is a tuning constant (typically defaulting to 0.2 for low voltage networks) that can be adjusted to account for extraordinary circumstances that may affect the time period calculation, such as extreme temperatures that affect the cooling rate of the transformer, which affects the efficiency and can extend or retract transition times before and after peak load conditions. Based on expressions (2) and (3), the transformer monitoring module 700 may extrapolate the winding energy loss over the same time period used for the iron loss (e.g., one year) and therefore determine the extrapolated winding energy loss using expression (4):

V_{K}(t)=T_{V}((1+rₘₐₓ)t−1(Pₘₐₓ)/P)²P_{K} (4)

In expression (4), (1+rₘₐₓ) is the load growth factor and is typically in the order of 1.01.

In the illustrated embodiment, the asset health analysis module 704 uses incoming specification, geography, and sensor data to generate health analysis data for the specified asset. In some embodiments, the asset health analysis module 704 generates aging conditions data for the specified asset using a transformer aging model. There are various known aging models that may be used by the asset health analysis module 704.

For example, in some embodiments, the asset health analysis module 704 uses known techniques for modeling transformer aging based on a top-oil temperature rise and a superimposed thermal gradient representing a hot-spot temperature rise. In some such embodiments, transformer aging is modeled by solving the heat transfer equations for the top-oil temperature and the hot-spot temperature in the windings. In some embodiments, the asset health analysis module 704 receives time-series sensor data from one or more temperature sensors (e.g., temperature sensor sentiment analysis module 508 of FIG. 5) that includes data indicative of the top-oil temperature and the hot-spot temperature in the windings. In some such embodiments, the asset health analysis module 704 receives the time-series temperature data and generates aging conditions data representative of an operational age of the transformer based at least in part on the time-series temperature data from the temperature sensor. Transformers age at different rates based on the ambient temperature, load, cooling mechanism, and insulation type. The hot-spot temperature will degrade some types of insulation faster than others. For example, paper insulation is particularly susceptible to damage caused by excessive heat. The break-down of the insulation is essentially irreversible damage, thus having the affect of aging the transformer. Thus, the operational age provides a more accurate indication of the health condition of a transformer, and thereby allows for a more accurate prediction of an amount of time that the transformer is likely to remain operational.

In some embodiments, the asset health analysis module 704 uses a failure rate prediction model to predict the failure probability of a transformer. For example, in some embodiments, the asset health analysis module 704 calculates failure probability distribution data indicative of the likelihood of a transformer failure occurring over a specified period of time. In some embodiments, the probability distribution has a maximum probability value that indicates when a failure of the specified transformer is most likely to occur. In some such embodiments, the asset health analysis module 704 calculates the probability distribution for a specified transformer using a Weibull distribution model as the failure rate prediction model as shown in expression (5):

$$F ( t ) = 1 - {e}^{- {( \frac{t}{η} )}^{β}} \qquad ( 5 )$$

In expression (5), β is a shape parameter and η is a scale parameter. The shape parameter (β) affects the “skew” of the distribution such that for β<1, the failure rate would generally decrease over time, for β>1, the failure rate would generally increase over time, and for β=1 the failure rate is constant over time. The scale parameter (η) affects the “width” of the distribution such that as η decreases, the distribution approaches a tall, narrow spike, whereas as η increases, the height of the distribution decreases as the distribution curve widens.

In some embodiments, the shape parameter (β) and the scale coefficient (η) are based on past failure rates of transformers. For example, in some embodiments, the asset health analysis module 704 trains the Weibull distribution model using historical failure rate data indicative of specific past failure rates of similar transformers. In some such embodiments, the asset health analysis module 704 trains the Weibull distribution model using a training algorithm, such as regression or maximum likelihood estimation (MLE), to determine the shape parameter (β) and the scale coefficient (η) that will yield the most accurate trained failure rate prediction model. However, over time, as newer transformers replace aging transformers in a power distribution system, the failure rate of the newer transformers may differ from those being replaced. Therefore, in some embodiments, the asset health analysis module 704 periodically re-trains the Weibull distribution model (e.g., using regression or MLE) to determine updated shape parameter (β) and scale coefficient (η) values that will improve the accuracy of the trained failure rate prediction model for the newer transformers. In some such embodiments, where historical data for actual failures of the newer transformers is not yet available, the asset health analysis module 704 re-trains the Weibull distribution model using failure rate data received from the manufacturer or another third party or using failure rate data that has been generated based on specification data from the manufacturer.

In the illustrated embodiment, the network connection module 706 uses incoming specification and network data to generate capacity limit and network impact data for the identified asset. In some embodiments, the capacity data can be extracted from specification data for the specified transformer. For example, the specification data typically will include information regarding operational limits of the transformer, such as voltage and power ratings, temperature ratings, etc. In some embodiments, this information is used for replacement planning to automatically source a replacement, or provide users with replacement options, that match the capacity limits of the transformer being replaced. Also, in some embodiments, the network connection module 706 uses incoming network data for the specified asset, particularly regarding portions of the power distribution network that are connected directly to, or dependent in some way upon, the specified asset. In some embodiments, the information about the power distribution network provides an indication as to the extent to which the power distribution network presently depends on the specified asset, including dependencies and interactions between the distribution transformer and other assets. This information allows for replacement or other maintenance activities to be planned so as to minimize scheduled or unscheduled down time due to unforeseen dependencies or failures.

In the illustrated embodiment, the alert module 708 monitors incoming data for values associated with specified alert conditions and, responsive to such data, the alert module 708 automatically generates and issues alerts associated with the specified alert conditions. Non-limiting examples of alerts automatically generated and issued by the alert module 708 include writing to a log file, displaying a message, and/or sending an email or other type of message. Non-limiting examples of alert conditions include non-standard environmental or operational states of a distribution transformer, such as an extreme temperature that is above or below a standard operating temperature range, an open access panel, or a momentary anomalous current or voltage level.

In the illustrated embodiment, the action trigger module 710 monitors incoming data for values associated with specified event conditions and, responsive to such data, the action trigger module 710 automatically triggers events associated with the specified event conditions. Non-limiting examples of events automatically triggered by the action trigger module 710 include various simple actions, such as detecting a current spike and generating log data to record the current spike as an anomaly. In some embodiments, other examples of triggered actions may include more complex actions, for example fault location, isolation, and service restoration (FLISR) actions, such as locating faults and automatically restoring the distribution grid using advanced distribution automation equipment typically included in Smart Grid deployments.

In the illustrated embodiment, the replacement schedule module 712 enhances the maintenance automation aspects of the transformer monitoring module 700 by providing automated asset replacement schedule data representative of replacement recommendations on a component by component basis for assets included in a monitored power distribution network. In some embodiments, the replacement schedule module 712 periodically performs a replacement optimization analysis on each transformer or other asset in an electric power delivery system (e.g., electric power delivery system 201 of FIG. 2) and updates the schedule as necessary based on updated incoming data. In some embodiments, the replacement schedule module 712 performs the replacement optimization analysis on a particular transformer or other asset in an electric power delivery system “on demand” (i.e., responsive to a system or user request for an energy loss analysis of a particular transformer or other asset). In some embodiments, the replacement schedule module 712 collects the energy efficiency data generated by the energy loss model 702, aging conditions data and failure probability distribution data generated by the asset health analysis module 704, and system impact data and capacity limit data generated by the replacement schedule module 712. The replacement schedule module 712 then generates optimized replacement data for replacing the specified asset using the energy efficiency data, aging conditions data, failure probability distribution data, and system impact data.

In some embodiments, the replacement schedule module 712 uses the energy efficiency data, aging conditions data, failure probability distribution data, and system impact data to compute the total cost of ownership (TCO) of combined time periods before and after replacement at any point in time as measured in years. In some embodiments, the TCO includes three components: the replacement cost, the failure cost, and the energy losses. In some such embodiments, TCO(t_{R}) is a function of the replacement time point t_{R}, which is minimized using an optimization algorithm that accounts for:
Interest earned r using capital invested i until used to purchase a new transformer;
All costs, including the energy losses, replacements, and failures, quantified in terms of MWh;
The replacement cost (MWh) as a constant over time; and
Budget and crew availability constraints.
   An exemplary optimization model is presented below that uses the parameters shown in Table 1 below:

TABLE 1

| | |
|---|---|
| Pᵣ^{m} | rated power of transformer m; |
| C^{R, m} | replacement cost of transformer m; |
| T | number of years in the time horizon; |
| t_{R} | time replacement interval; |
| M | set of new transformers; |
| uₘ | =1 if transformer m is used; |
| c₁^{R} | replacement cost for the new transformer; |
| a₁ | coefficient cost for copper loss for the new transformer; |
| b₁ | cost for iron loss for the new transformer; |
| Pᵣ¹ | new transformer capacity; |
| R^{max} | maximum capacity ratio |

In the exemplary model, the capitalized loss during the t-th year for the m-th transformer can be rewritten as:

b^{m}+a^{m}(Pₘₐₓ/Pᵣ^{m}(1+rₘₐₓ)^{t-1})²[MWh]

where the first term is the copper loss and the second one is the iron loss. The energy loss before the replacement is:

$$\text{?}$$

$$\text{?} \text{indicates text missing or illegible when filed}$$

and the energy loss after the replacement is:

$$\text{?}$$

$$\text{?} \text{indicates text missing or illegible when filed}$$

The interest gain over n years is compounded capital invested over t R years minus initial investment and that itself invested again over the remaining years, which is:

(1+r)^{T+1-i}^{₂}((I+r)^{t}^{_{R}}⁻¹−1)c₁^{R}[MWh]

The failure cost is computed from:

c_{F}(∫₀^{τ}^{_{R}}⁻ⁱh₀(t)dt+∫₀^{T+1-r}^{_{R}}h_{R}(t)dt)[MWh]

Hence, we solve the following optimization to determine the optimal replacement time for a transformer with decision variables t_{R}, uₘ, c₁^{R}, a₁, b₁, P_{R}¹, h_{R} as follows:

$$\text{?}$$

$$\text{?} \text{indicates text missing or illegible when filed}$$

such that:
binary variable condition:

$${{\sum }_{m = 1}}^{M} {u}_{m} = 1 , {u}_{m} ∈ \{ 0 , 1 \}$$

new transformer features:

$${C}_{1}^{R} = {{\sum }_{m = 1}}^{M} {C}^{R , m} {u}_{m} , {a}_{1} = {{\sum }_{m = 1}}^{M} {a}^{m} {u}_{m} , {b}_{1} = {{\sum }_{m = 1}}^{M} {b}^{m} {u}_{m}$$

$${P}_{r}^{1} = {{\sum }_{m = 1}}^{M} {P}^{r , m} {u}_{m} , {h}_{R} ( r ) = {{\sum }_{m = 1}}^{M} {h}^{m} ( t ) {u}_{m}$$

subject to the over-capacity constraint:

log(Pₘₐₓ)+(t_{g}−1)log(1+rₘₐₓ)−log(Pₜ^{G})−log(R^{max})≤0

log(Pₘₐₓ)+(T+1)log(1+rₘₐₓ)−log(P^{I})−log(R^{max})≤0

Thus, the replacement schedule module 712 can be configured to generate replacement data indicative of an optimal replacement schedule in that the replacement data is representative of a future point in time that is an optimal time for replacing the specified transformer. The precision or specificity of the actual time frame indicated by the optimal time for replacing the specified transformer may vary in different embodiments. For example, in some embodiments, the indication of a future point in time is an indication of a future year such that the future year constitutes the optimal time for replacing the associated transformer. The replacement schedule module 712 advantageously considers energy loss, capacity limit, and asset health conditions in determining an optimal number of years until the transformer should be replaced. The above is an example of an economic model that considers energy loss with space and time information together with capacity limit and asset health data. The replacement schedule module 712 can be configured to consider the scheduling problem at a system level by optimizing the replacement schedule using the temporal and spatial energy loss information.

The exemplary model also provides a scalable approach for a large-scale system with resource constraints. In some embodiments, the replacement schedule module 712 generates a replacement schedule for a plurality of transformers. In some such embodiments, the replacement schedule module 712 generates a replacement schedule for replacing a fleet of transformers or all transformers in an electric power delivery system (e.g., electric power delivery system 201 of FIG. 2). In some embodiments, the replacement schedule module 712 generates a replacement schedule for a fleet of transformers under budget and operational constraints based at least in part on total cost of ownership data for the fleet of transformers. In some such embodiments, the replacement schedule module 712 accounts for operational and economical constraints for the entire electric power delivery system, such as labor and budget availability for each time period to avoid constraint violations that could potentially occur when scheduling individual transformers. Thus, in some such embodiments, the replacement schedule module 712 generates a replacement schedule for a plurality or fleet of transformers using global constraints to adjust future points in time that were previously calculated for each of the transformers on an individual basis. In some such embodiments, the replacement schedule module 712 uses a model that minimizes adjustments to the previously-calculated future points in time for each of the transformers. Some such embodiments use an exemplary optimization model presented below that uses the parameters shown in Table 2:

TABLE 2

| | |
|---|---|
| S | set of transformers; |
| T | time horizon; |
| wₛ | criticality metric of the s-th transformer; |
| t^{s} | optimal replacement time for the s-th transformer obtained from |
| | the first stage (without constraints); |
| h^{R} | manpower for replacing a transformer; |
| C^{R} | cost ($) for a replacement of the s-th transformer; |
| bₜ | maximum budget availability during the t-th time period; |
| b_{T}_{ₖ} | maximum budget availability during a certain time block Tk; |
| m̅ | total budget availability; |
| pₜ | crew availability during the t-th period; |
| z^{t}ₛ | ∈ {0, 1}, =1 if a replacement is performed for the s-th |
| | transformer at the t period; |
| δ | maximum allowed deviation in the replacement time; |
| TCOT*ₛ | optimal TCO for the s-th transformer without constraints; |
| TCO^{t}ₛ | the TCO for the s-th transformer at time t; |

In some such embodiments, the replacement schedule module 712 schedules replacements and determines if a loan is needed for a specific time based on the optimal replacements t^{s} for the set of transformers from the last step and the total budget m̅ over T years.

The replacement schedule module 712 minimizes the total cost increase and the capital investment with decision variables (z^{t}ₛ, cₜ):

$${min}_{{z}_{s}^{t} , {c}_{t}} {\sum }_{s , t} {w}_{s} {z}_{s}^{t} \vert {TCO}_{s}^{t} - {TCO}_{s}^{*} \vert + {\sum }_{t} {m}_{t}$$

where the above objective function is subject to the following set of constraints:
A replacement for the s-th transformer:

$${\sum }_{{t}^{s} - δ \leq t \leq {t}^{s} + δ} {z}_{s}^{t} = 1 , ∀ t , s$$

Crew availability at the t-th period:

$${\sum }_{S = 1 , … , S} {h}^{R} {z}_{s}^{t} \leq {p}_{t} , ∀ t$$

Budget availability at the t-th period:

$${\sum }_{s} {C}_{s}^{R} {z}_{s}^{t} \leq {m}_{t} , ∀ t$$

Budget availability for a certain time block Tₖ:

$${\sum }_{t ∈ {T}_{k}} {m}_{t} \leq {m}_{{T}_{k}} , ∀ t , k$$

The above optimization problem is a mixed-integer linear program (MILP). Thus, in some such embodiments, the replacement schedule module 712 uses any known MILP solver to reach a solution.

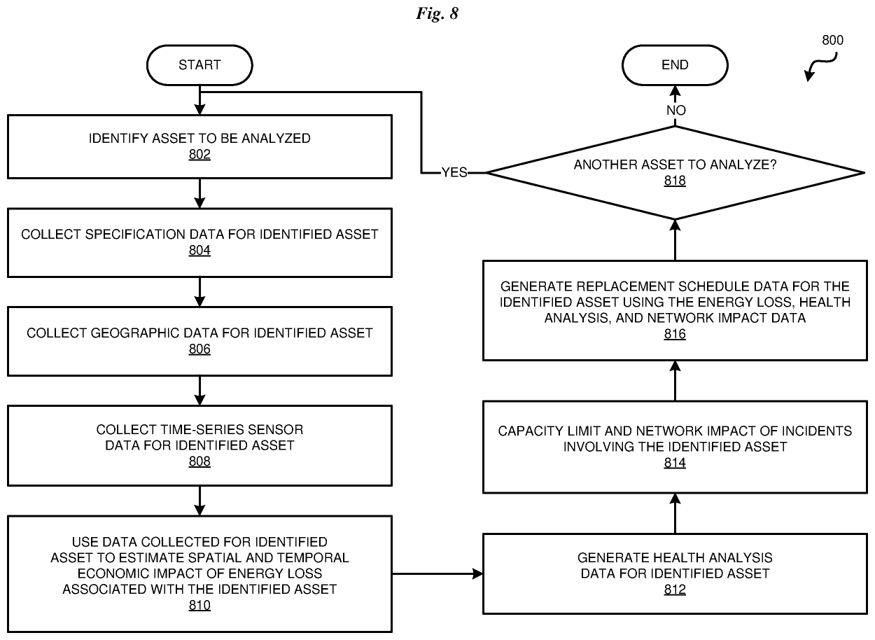

With reference to FIG. 8, this figure depicts a flowchart of an example process 800 for monitoring a transformer in accordance with an illustrative embodiment. In a particular embodiment, the transformer monitoring module 700 carries out the process 800.

In the illustrated embodiment, at block 802, the process identifies an asset to be analyzed. Next, at block 804, the process collects specification data for identified asset. Next, at block 806, the process collects geographic data for identified asset. Next, at block 808, the process collects time-series sensor data for identified asset. Next, at block 810, the process uses the data collected for identified asset to estimate a spatial and temporal economic impact of energy loss associated with the identified asset. Next, at block 812, the process generates health analysis data for the identified asset. Next, at block 814, the process generates capacity limit and network impact data of incidents involving the identified asset. Next, at block 816, the process generates replacement schedule data for the identified asset using the energy loss, health analysis, and network impact data. Next, at block 818, the process determines whether another asset is available for analysis. If so, the process returns to block 802; otherwise, the process ends.

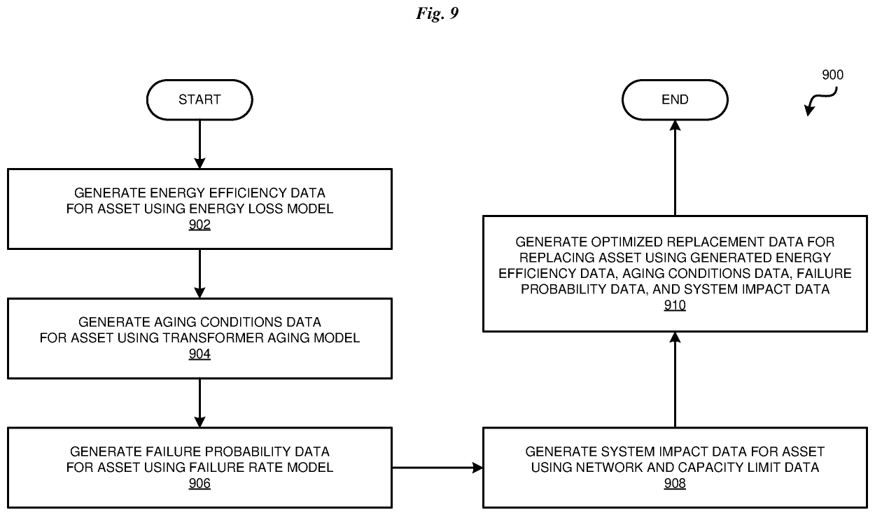

With reference to FIG. 9, this figure depicts a flowchart of an example process 900 for generating an optimal replacement schedule in accordance with an illustrative embodiment. In a particular embodiment, the replacement schedule module 712 carries out the process 900.

In an embodiment, at block 902, the process generates energy efficiency data for a specified asset using an energy loss model. Next, at block 904, the process generates aging conditions data for the specified asset using a transformer aging model. Next, at block 906, the process generates failure probability distribution data for the specified asset using a failure rate prediction model. Next, at block 908, the process generates system impact data for the specified asset using network and capacity limit data. Next, at block 910, the process generates optimized replacement data for replacing the specified asset using generated energy efficiency data, aging conditions data, failure probability distribution data, and system impact data.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
receiving, by a transformer monitoring system associated with a transformer, sensor data from one or more sensors during operation of the transformer;
generating, by the transformer monitoring system, energy loss data representative of a predicted energy loss of the transformer based at least in part on the sensor data from the one or more sensors;
training, by the transformer monitoring system, a failure rate prediction model using failure data, resulting in a trained failure rate prediction model that calculates probability distribution data indicative of a time at which a failure of the transformer is most likely to occur; and
generating, by the transformer monitoring system, replacement data representative of an optimal time for replacing the transformer based at least in part on the energy loss data, the probability distribution data, and specification data for the transformer.

2. The computer-implemented method of claim 1, further comprising:
receiving, by the transformer monitoring system, sensed temperature data of the transformer from a temperature sensor during operation of the transformer.

3. The computer-implemented method of claim 2, further comprising:
generating, by the transformer monitoring system, aging conditions data representative of an operational age of the transformer based at least in part on the sensed temperature data from the temperature sensor.

4. The computer-implemented method of claim 3, wherein the generating of the replacement data is further based at least in part on the aging conditions data.

5. The computer-implemented method of claim 1, further comprising:
generating, by the transformer monitoring system, core energy loss data representative of a predicted core energy loss of a core of the transformer.

6. The computer-implemented method of claim 5, wherein the generating of the core energy loss data is based at least in part on the specification data of the transformer.

7. The computer-implemented method of claim 5, further comprising:
generating, by the transformer monitoring system, winding energy loss data representative of a predicted winding energy loss of a winding structure of the transformer.

8. The computer-implemented method of claim 7, wherein the generating of the winding energy loss data is based at least in part on the sensor data from the one or more sensors.

9. The computer-implemented method of claim 7, wherein the generating of the energy loss data is further based at least in part on the core energy loss data and the winding energy loss data.

10. The computer-implemented method of claim 1, wherein the training of the failure rate prediction model comprises using a maximum likelihood estimation algorithm to train a Weibull distribution model resulting in the trained failure rate prediction model.

11. The computer-implemented method of claim 10, wherein the training of the Weibull distribution model comprises determining a shape parameter and a scale coefficient.

12. The computer-implemented method of claim 1, wherein the generating of the replacement data comprises generating replacement data representative of optimal times for replacing a fleet of transformers under budget and operational constraints based at least in part on total cost of ownership data for the fleet of transformers, the fleet of transformers comprising said transformer.

13. A computer program product comprising one or more computer readable storage media, and program instructions collectively stored on the one or more computer readable storage media, the program instructions executable by a processor to cause the processor to perform operations comprising:
receiving, by a transformer monitoring system associated with a transformer, sensor data from one or more sensors during operation of the transformer;
generating, by the transformer monitoring system, energy loss data representative of a predicted energy loss of the transformer based at least in part on the sensor data from the one or more sensors;
training, by the transformer monitoring system, a failure rate prediction model using failure data, resulting in a trained failure rate prediction model that calculates probability distribution data indicative of a time at which a failure of the transformer is most likely to occur; and
generating, by the transformer monitoring system, replacement data representative of an optimal time for replacing the transformer based at least in part on the energy loss data, the probability distribution data, and specification data for the transformer.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 13, further comprising:
receiving, by the transformer monitoring system, sensed temperature data of the transformer from a temperature sensor during operation of the transformer.

17. The computer program product of claim 13, wherein the generating of the replacement data comprises generating replacement data representative of optimal times for replacing a fleet of transformers under budget and operational constraints based at least in part on total cost of ownership data for the fleet of transformers, the fleet of transformers comprising said transformer.

18. A computer system comprising a processor and one or more computer readable storage media, and program instructions collectively stored on the one or more computer readable storage media, the program instructions executable by the processor to cause the processor to perform operations comprising:
receiving, by a transformer monitoring system associated with a transformer, sensor data from one or more sensors during operation of the transformer;
generating, by the transformer monitoring system, energy loss data representative of a predicted energy loss of the transformer based at least in part on the sensor data from the one or more sensors;
training, by the transformer monitoring system, a failure rate prediction model using failure data, resulting in a trained failure rate prediction model that calculates probability distribution data indicative of a time at which a failure of the transformer is most likely to occur; and
generating, by the transformer monitoring system, replacement data representative of an optimal time for replacing the transformer based at least in part on the energy loss data, the probability distribution data, and specification data for the transformer.

19. The computer system of claim 18, further comprising:
receiving, by the transformer monitoring system, sensed temperature data of the transformer from a temperature sensor during operation of the transformer.

20. The computer system of claim 18, wherein the generating of the replacement data comprises generating replacement data representative of optimal times for replacing a fleet of transformers under budget and operational constraints based at least in part on total cost of ownership data for the fleet of transformers, the fleet of transformers comprising said transformer.
